(19) United States
(12) Patent Application Publication
(10) Pub. No.: US 2025/0315301 A1
(43) Pub. Date: Oct. 9, 2025

(54) SEMICONDUCTOR DEVICE, APPLICATION ALLOCATION SYSTEM, APPLICATION ALLOCATION METHOD, AND NON-TRANSITORY COMPUTER READABLE MEDIUM

(71) Applicant: Renesas Electronics Corporation, Tokyo (JP)

(72) Inventors: Hirofumi SHIGEHISA, Tokyo (JP); Takuya TOYOSHIMA, Tokyo (JP); Takahiro HASHIMOTO, Tokyo (JP); Yoshiki AZUMA, Tokyo (JP)

(21) Appl. No.: 19/071,008

(22) Filed: Mar. 5, 2025

(30) Foreign Application Priority Data
Apr. 8, 2024 (JP) 2024-062243

(51) Int. Cl. G06F 9/50

(52) U.S. Cl. CPC G06F 9/5027

(57) ABSTRACT

A semiconductor device includes an application allocation judgement unit and an application allocation control unit. The application allocation judgement unit compares CPU usage rate data and CPU usage rate threshold pattern data, thereby predicting a state in which the CPU usage rate exceeds a threshold value and generating an application allocation change request. The application allocation control unit changes an allocation destination of an application allocated to the CPU predicting that the CPU usage rate exceeds the threshold value based on the application allocation change request.

### CROSS-REFERENCE TO RELATED APPLICATIONS

The present application claims priority from Japanese Patent Application No. 2024-062243 filed on Apr. 8, 2024, the content of which is hereby incorporated by reference to this application.

### BACKGROUND

The present disclosure relates to a semiconductor device, an application allocation system, an application allocation method, and a non-transitory computer readable medium.

There is a function of an orchestration in a cloud system. The orchestration is a function of automating setting, management, and adjustment of applications across a computer system configurating the cloud system, thereby making it possible to ensure efficiency at a time of executing the applications. Therefore, the orchestration is expected about application to various fields like vehicle mounting and the like.

There is disclosed a technique listed below.

### [Patent Document 1] Japanese Unexamined Patent Application Publication No. 2019-219931

As a specific method for ensuring the efficiency at the time of executing the applications, there are techniques for determining a Central Processing Unit (CPU) that executes the applications and performs tasks depending on load conditions of the CPU. For example, Patent Document 1 discloses a semiconductor integrated circuit that determines, as an execution destination CPU of the tasks, the high-performance CPU when a CPU usage rate exceeds a reference usage rate (threshold value) and that determines, as an execution destination CPU of the tasks, the low-performance CPU when the CPU usage rate does not exceed the threshold value.

### SUMMARY

In a technique disclosed in Patent Document 1, the CPUs that are allocation destinations of the applications and the tasks are determined depending on whether the CPU usage rate exceeds or not the threshold value. That is, the allocation destinations of the applications and the tasks are changed for the first time after the CPU usage rate exceeds the threshold value, so that a heavy condition of a processing load of the CPU continues until allocation of the applications and the tasks is switched. In the heavy conditions of the processing load of the CPU, delay of execution processing of the applications easily occurs, for example, occurrence risks like deterioration and the like of responses in a user interface increase.

Meanwhile, in order to prevent the processing loads of the CPU from becoming the heavy conditions, it is also conceivable to make the threshold value low. However, lowering the threshold value easily brings occurrence of a situation in which the CPU usage rate exceeds the threshold value, and an execution frequency of a switching processing for switching the application and the task increases. This leads to allocating resources of the CPU for executing the original application and performing the original task, thereby lowering performance.

Other problems and novel features will be apparent from the present specification and the accompanying drawings.

A semiconductor device according to one embodiment includes an application allocation judgement unit and an application allocation control unit. The application allocation judgment unit compares latest CPU usage rate data and CPU usage rate threshold pattern data of any one CPU among a plurality of CPUs, thereby predicting a state in which the CPU usage rate exceeds a threshold value and generating an application allocation change request. The application allocation control unit changes an allocation destination of an application, which is allocated to the any one CPU among the plurality of CPUs, to the other CPU among the plurality of CPUs based on the application allocation change request.

According to the present disclosure, by predicting the state in which the usage rate of the any one CPU among the plurality of CPUs exceeds the threshold value, the allocation destination of the application allocated to the above CPU is changed to the other CPU. Consequently, since it can be avoided that the CPU usage rate exceeds the threshold value, the occurrence risks like the deterioration and the like of the response of the user interface can be reduced. In addition, since setting the low threshold value is not required, the resource of the CPU can be prevented from being allocated at a time of a switching processing occurring for the allocation change of the application and maintaining performance can be achieved.

### BRIEF DESCRIPTION OF THE DRAWINGS

FIG. 1 is a block diagram showing one example of a hardware configuration of an application allocation system according to an embodiment.

FIG. 2 is a block diagram showing one example of a functional configuration of the application allocation system according to the embodiment.

FIG. 3 is a block diagram showing one example of a functional configuration of an application allocation judgement unit according to the embodiment.

FIG. 4 is a diagram for explaining a pattern matching processing.

FIG. 5 is a flowchart showing one example of a processing flow of a semiconductor device.

FIG. 6 is a flowchart showing one example of a processing flow of a server.

### DETAILED DESCRIPTION

Hereinafter, embodiments of the present invention will be described in detail with reference to the accompanying drawings. Note that components having the same function are denoted by the same reference characters throughout the drawings for describing the embodiments, and the repetitive description thereof will be omitted. Further, in the drawings, the components may be omitted or simplified for convenience of explanation.

Programs may be stored in various types of non-transitory computer readable medium or tangible storage medium. As an example, not a limitation, the non-transitory computer readable medium or tangible storage medium includes a Random Access Memory (RAM), a Read Only Memory (ROM), a flash memory, a Solid State Drive (SSD), or the other memory techniques, a Compact Disc (CD)-ROM, a Digital Versatile Disc (DVD), a Blu-ray (registered trademark) disc, or the other optical disc storages, a magnetic cassette, a magnetic tape, a magnetic disc storage, or the other magnetic storage devices. In addition, the programs may be transmitted on the various types of transitory computer readable medium or communication medium. As an example, not a limitation, the transitory computer readable medium or communication medium includes electrical, optical, acoustic, or the other types of propagation signals.

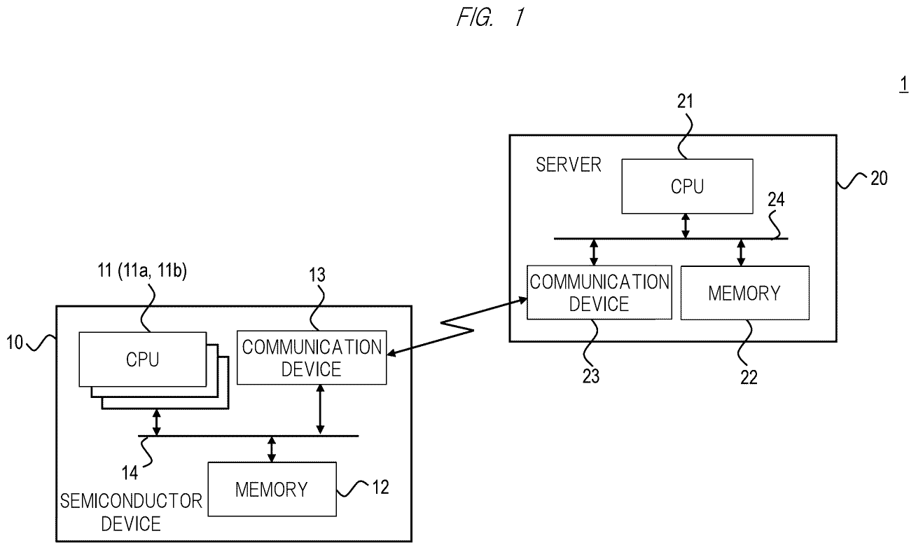

First, a hardware configuration of an application allocation system according to an embodiment. FIG. 1 is a block diagram showing one example of a hardware configuration of an application allocation system 1 according to the embodiment. As shown in FIG. 1, the application allocation system 1 includes a semiconductor device 10 and a server 20. The semiconductor device 10 and the server 20 are communicably configurated via a network such as an Internet and a mobile communication system. For example, when the application allocation system 1 is applied to an on-vehicle system, the semiconductor device 10 is built in an electronic control unit mounted to a vehicle and the server 20 is used as a cloud server.

The semiconductor device 10 includes a plurality of CPUs 11, a memory 12, a communication device 13, and a bus 14. The plurality of CPUs 11, the memory 12, and the communication device 13 can be configurated so as to be connected to the bus 14 and be mutually accessible via the bus 14.

Each of the plurality of CPUs 11 execute the application allocated among the plurality of applications. In addition, the plurality of CPUs 11 includes at least a CPU 11a and a CPU 11b. Note that in the present disclosure, when any CPU among the plurality of CPUs 11 is indicated, it is simply denoted by the CPU 11.

The memory 12 can a program(s) for controlling a plurality of applications and an application allocation method that are executed by the CPU 1. Hereinafter, the program for controlling the application allocation method executed by the CPU 11 is called a first control program. The semiconductor device 10 has a not-shown input/output interface. The plurality of applications and the first control program are inputted in the input/output interface of the semiconductor device 10 via various types of transitory or non-transitory computer readable medium, and are stored in the memory 12. Note that a type of the memory 12 is not limited particularly, and the present embodiment can use various types of non-transitory computer readable medium.

The communication device 13 is configured so as to transmit, to the server 12, data generated in the semiconductor device 10. In addition, the communication device 13 is configured so as to receive data transmitted from the server 20.

The server 20 includes a CPU 21, a memory 22, 1 communication device 23, and a bus 24. The CPU 21, the memory 22, and the communication device 23 can be configured to so as to be connected to the bus 24 and to be mutually accessible via the bus 24.

The memory 22 can store a program for controlling the application allocation method executed by the CPU 21. Hereinafter, the program for controlling the application allocation method executed by the CPU 21 is called a second control program. The server 20 has a not-shown input/output interface. The second control program is inputted in the input/output interface of the server 20 via various types of transitory or non-transitory computer readable medium, and is stored in the memory 22. Note that a type of the memory 22 is not limited particularly, and the present embodiment can use the various types of non-transitory computer readable medium.

The communication device 23 is configurated so as to transmit, to the semiconductor device 10, data generated in the server 20. In addition, the communication device 23 is configurated so as to receive the data transmitted from the semiconductor device 10.

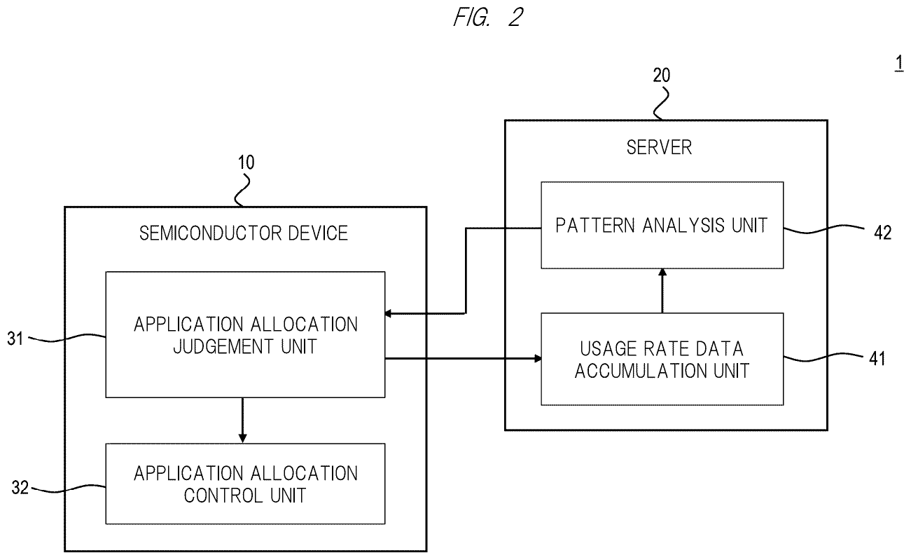

Next, the functional configuration of the application allocation system according to the present embodiment will be explained. FIG. 2 is a block diagram showing one example of the configuration of functional the application allocation system 1 according to the present embodiment.

As shown in FIG. 2, the semiconductor device 10 includes an application allocation judgement unit 31 and an application allocation control unit 32. A part or all of functions of two functional blocks of the application allocation judgement unit 31 and the application allocation control unit 32 is realized by the CPU 11 executing the first control program.

The application allocation judgement unit 31 is connected to the application allocation control unit 32 and the server 20. The application allocation judgement unit 31 generates CPU usage rate data of each of the plurality of CPUs 11, and transmits it to the server 20. The CPU usage rate data is data indicating a rate in which the executing program occupies a processing time of the CPU. That a CPU usage rate is high means that a processing load of the CPU is in a heavy state.

In addition, the application allocation judgement unit 31 receives a CPU usage rate threshold pattern data from the The CPU usage rate threshold pattern data is server 20. data generated by analyzing the accumulated CPU usage rate data of each of the plurality of CPUs 11. Details of the CPU usage rate threshold pattern data will be explained later. The application allocation judgement unit 31 generates an application allocation change request in comparison with the latest CPU usage rate data and the latest CPU usage rate threshold pattern data of each of the plurality of CPUS 11. The application allocation change request is a signal for requesting a change of an allocation destination of the application. Therefore, the application allocation change request includes information for specifying the application that is an object of an allocation change, information for specifying the CPU 11 of the allocation destination, and the like. The generated application allocation change request is outputted to the application allocation control unit 32.

The application allocation control unit 32 receives application request the from the allocation change application allocation judgement unit 31. The application allocation control 32 unit changes the allocation destination of the application, which is allocated to any one CPU 11 among the plurality of CPUs 11, to the other CPU 11 among the plurality of CPUs 11 based on the application allocation change request.

For example, out of applications A, B allocated to the CPU 11a, as execution destinations, when the allocation destination of the application B is requested to the change to the CPU 11b, the application allocation change request includes information indicating that the application to be an object of the allocation change is the application B and the allocation destination to be changed is the CPU 11b. In this case, the application allocation control unit 32 changes, to the CPU 11b, the allocation destination of the application B allocated to the CPU 11a based on the application allocation change request.

In addition, as shown in FIG. 2, the server 20 includes a usage rate data accumulation unit 41 and a pattern analysis unit 42. A part or all of two functional blocks of the usage rate data accumulation unit 41 and the pattern analysis unit 42 is realized by the CPU 21 executing the second control program.

The usage rate data accumulation unit 41 receives the CPU usage rate data of each of the plurality of CPUS 11 transmitted from the semiconductor 10, device and accumulates it. Note that the usage rate data accumulation unit 41 accumulates the CPU usage rate data so that the CPU usage rate data of which CPU 11 the accumulated CPU usage rate data is can be specified.

The pattern analysis unit 42 analyzes the CPU usage rate data of each of the plurality of CPUs 11 accumulated in the usage rate data accumulation unit 41, and generates CPU usage threshold pattern data. The accumulated CPU usage rate data is analyzed by using a time series data prediction model to make feature prediction of the CPU usage rate.

As the time series data prediction model, for example, an Auto Regressive Moving Average (ARMA) model, an Auto Regressive Integrated Moving Average (ARIMA) model, a Seasonal Auto Regressive Integrated Moving Average (SARIMA) model, a Prophet model, and the like can be used.

The ARMA model is an effective model for prediction when a data mean and variance are constant. Therefore, it is preferably to use the ARAM model when the future CPU usage rate is predicted with respect to such an application as that the mean and variance of the CPU usage rate data are constant.

The ARMA model is an effective model for the prediction when the average and variance of the CPU usage rate data are not constant. Therefore, when the future CPU usage rate is predicted with respect to such an application that the average and variance of the CPU usage rate data are not constant, it is preferably to use the ARIMA model.

The SARIMA model is a model obtained by adding a seasonal cycle pattern to the ARIMA model. Therefore, when the future CPU usage rate is predicted with respect to the application having the seasonal cycle pattern among the applications analyzed by the ARIMA model, it is preferably to use the SARIMA model. For example, in a vehicle to which a sheet heater is mounted, a system application for managing the sheet heater is operated. Since the sheet heater is mainly used in winter, it is assumed the system application performs more processings in winter than in summer. In such a case, there is a high possibility that using the SARIMA model will obtain a more effective analysis result(s) than using the ARIMA model.

The Prophet model is a model obtained by modeling each of four pieces of data and combining them. The Prophet model is configured by four terms of a growth function term, a periodic function term, a holiday effect term, and an error term (noise). The growth function term corresponds to data monotonically fluctuated along with time. The periodic function term corresponds to data periodically and repeatedly fluctuated. The holiday effect term corresponds to data fluctuated depending on dates of an irregular calendar. The error term corresponds to data that does not apply to any of the above three models and that is randomly fluctuated.

In the present disclosure, it is assumed to use the Prophet model at a short-term cycle of one day and a long-term cycle of one year. For example, when an on-vehicle usage application is considered, in the short-term cycle the growth function term assumes the CPU usage rate fluctuated as time advances from activation of the application, the periodic function term assumes the CPU usage rate fluctuated by performing routine tasks at the same time every day through driving the same commuting route on weekends, and the holiday effect term assumes the CPU usage rate fluctuated by an irregular event such as congestion on a driving route and drive of a not normally traveling route. In addition, in the long-term cycle, the growth function term assumes the CPU usage rate fluctuated by updating version of the application, the periodic function term assumes the CPU usage rate fluctuated along with a season like the above sheet heater event, and the holiday effect term assumes the CPU usage rate fluctuated by a long vacation trip and the like.

The pattern analysis unit 42 uses the various time series data prediction models as described above to perform the future prediction of the CPU usage rate, thereby analyzing the CPU usage rate data of each of the plurality of CPUs 11. That is, in the analysis of the CPU usage rate data by the pattern analysis unit 42, the future CPU usage rate is predicted by using the past CPU usage rate data accumulated.

The pattern analysis unit 42 judges whether the future CPU usage rate predicted exceeds or not the threshold value. The threshold value is not limited particularly, but it is preferably to set, as a threshold value, a value of the CPU usage rate at which a processing load of the CPU increases and the application begins to behave erratically. For example, the threshold value may be set at a CPU usage rate of 80%.

The pattern analysis unit 42 generates, as CPU usage rate threshold pattern data, time series fluctuation pattern data of the CPU usage rate assumed so as to exceed the threshold value in the future based on the analysis result of the future prediction of the CPU usage rate. The CPU usage rate threshold pattern data is configurated from the time series fluctuation pattern data of an average CPU usage rate per certain time. For example, it is assumed that as a result of using the time series data prediction model to analyze the future prediction of the CPU usage rate, the average CPU usage rate per certain time is fluctuated like 40%, 60%, and 50% and a result of the subsequent CPU usage rate exceeding the threshold value is obtained. In this case, the pattern analysis unit 42 generates, as the CPU usage rate threshold pattern data, the time series fluctuation pattern data in which the average CPU usage rate per certain time is fluctuated like 40%, 60%, and 50%.

The pattern analysis unit 42 transmits the generated CPU usage rate threshold pattern data to the semiconductor device 10. Note that the pattern analysis unit 42 may generate a plurality of pieces of CPU usage rate threshold pattern data. In this case, the pattern analysis unit 42 transmits the plurality of pieces of CPU usage rate threshold pattern data to the semiconductor device 10.

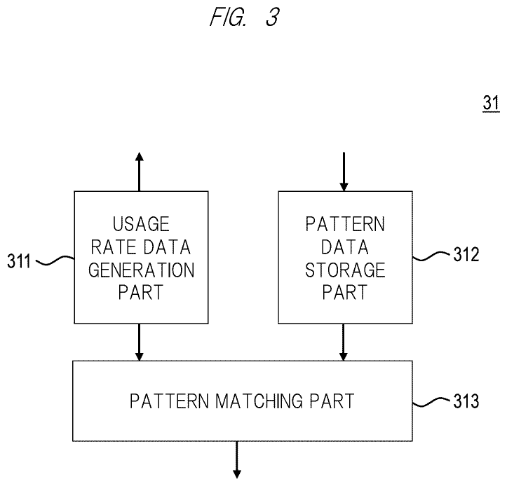

FIG. 3 is a block diagram showing one example of a functional configuration of the application allocation judgement unit 31 according to the embodiment. As shown in FIG. 3, the application allocation judgement unit 31 includes a usage rate data generation part 311, a pattern data storage part 312, and a pattern matching part 313.

The usage rate data generation part 311 generates the CPU usage rate data of each of the plurality of CPUs 11. The generated CPU usage rate data is outputted to the pattern matching part 313 and the server 20.

The pattern data storage part 312 receives the CPU usage rate threshold pattern data transmitted from the server and stores it. The CPU usage rate threshold pattern data stored in the pattern data storage part 312 is outputted to the pattern matching part 313.

The pattern matching part 313 compares the latest CPU usage data outputted from the usage rate data generation part 311 and the CPU usage rate threshold pattern data stored in the pattern data storage part 312. The pattern matching part 313 determines whether the latest CPU usage rate data and the CPU usage rate threshold pattern data match with each by comparing them. When determining that the latest CPU usage rate data and the CPU usage rate threshold pattern data match with each, the pattern matching part 313 predicts that the CPU usage rate exceeds the threshold value in the future.

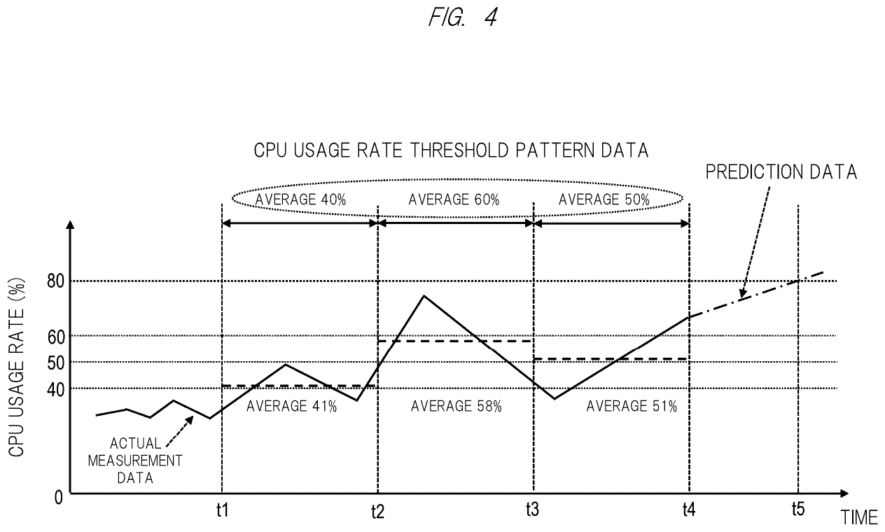

FIG. 4 is a diagram for explaining a pattern matching processing by the pattern matching part 313. In FIG. 4, a vertical axis corresponds to time, and a horizontal axis corresponds to the CPU usage rate of the CPU 11. In an example shown by FIG. 4, the CPU usage rate data by time t4 indicates data generated by the usage rate data generation part 311, that is, actual measurement data. In contrast, data after time t4 corresponds to prediction data.

As shown in FIG. 4, an average value of the CPU usage rate in an interval of t1 to t2 is 41%, an average value of the CPU usage rate in an interval of t2 to t3 is 58%, and an average value of the CPU usage rate in an interval of t3 to t4 is 51%. That is, the latest actual measurement data relative to the average CPU usage rate per certain time as shown in FIG. 4 is fluctuated like 41%, 58%, and 51%.

When the CPU usage rate threshold pattern data is the time series fluctuation pattern data of the average CPU usage rate that is 40%, 60%, and 50%, the pattern matching part 313 compares 41%, 58%, and 51%, which are the latest CPU usage rate data, and 40%, 60%, and 50%, which are the CPU usage rate threshold pattern data, and performs pattern matching. At this time, the pattern matching part 313 does not judge that they are exact match, considers whether they fall within a permissible range of prediction values, and performs match judgement. Considering the permissible range (for example, ±5%) of the prediction values, when it is determined that 41%, 58%, and 51%, which are the latest CPU usage rate data match with 40, 60%, and 50%, which are the CPU usage rate threshold pattern data, the pattern matching part 313 predicts that the CPU usage rate of the CPU 11 exceeds the threshold value in the future. In an example shown by FIG. 4, it is assumed that the CPU usage rate of the CPU 11 exceeds a CPU usage rate of 80%, which is a threshold value, at time t5.

In addition, when judging that the latest CPU usage rate data of any CPU 11 among the plurality of CPUs 11 and the CPU usage rate threshold pattern data match with each other, the pattern matching part 313 judges whether the other CPU 11 among the plurality of CPUs 11 has or not a vacancy of the CPU 11 usage rate necessary for executing a part of the application allocated to the CPU 11 predicting that the CPU usage rate exceeds the threshold value. When judging that the other CPU 11 among the plurality of CPUs 11 has the vacancy of the CPU usage rate necessary for executing a part of the application allocated to the CPU 11 predicting that the CPU usage rate exceeds the threshold value, the pattern matching part 313 generates an application allocation change request.

For example, it is assumed that application A and application B are allocated to the CPU 11a among the plurality of CPUs 11 and application C is allocated to the CPU 11b among the plurality of CPUs 11. When judging that the latest CPU usage rate data of the CPU 11a matches with the CPU usage rate threshold pattern data and that a vacancy of the CPU usage rate necessary for executing a part of application B allocated to the CPU 11b predicting that the CPU usage rate exceeds the threshold value exits, the pattern matching part 313 generates the application allocation change request containing information on changing the allocation of application B to the CPU 11b. Note that existence of the vacancy of the CPU usage rate indicates a state in which there is the vacancy of the CPU usage rate in the following degree; even when the application whose allocation destination is changed is further performed, the vacancy of the CPU usage rate exists in such a degree that a total of values of the changed CPU usage rates does not exceed the threshold value.

The application allocation change request is generated before the CPU usage rate exceeds the threshold value. In the example shown: in FIG. 4, the application allocation change request is generated in an interval of time t4 to time t5. Since the application allocation is changed based on the application allocation change request before a state of time t5, it becomes possible to lower the CPU usage rate and to avoid that the CPU usage rate actually exceeds the threshold value.

In this way, the application allocation judgment unit 31 compares the latest CPU usage rate data of any one CPU 11 among the plurality of CPUs 11 and the CPU usage rate threshold pattern data, thereby predicting the state in which the CPU usage rate of the CPU 11 exceeds the threshold value and generating the application allocation change request. Then, the application allocation control unit 32 changes the allocation destination of the application, which is allocated to any one CPU 11 among the plurality of CPUs 11, to the other CPU 11 among the plurality of CPUs 11 based on the application allocation change request.

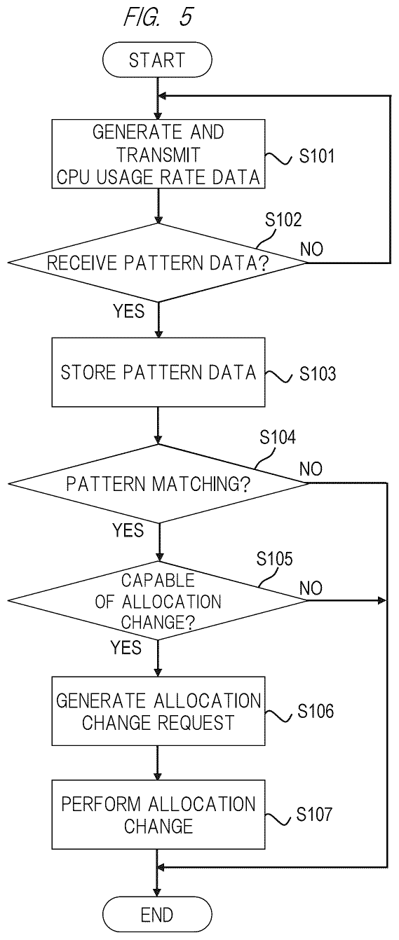

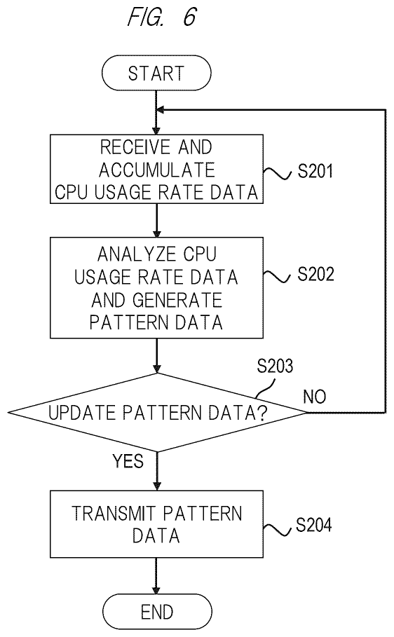

Subsequently, by using FIGS. 5 and 6, a processing flow of the application allocation system 1 according to the embodiment will be explained. FIG. 5 is a flowchart showing one example of a processing flow of the semiconductor device 10. The flowchart in FIG. 5 includes seven processing steps composed of step S101 to step S107.

In step S101, the usage date generation part 311 generates the CPU usage rate data of each of the plurality of CPUS 11. The usage rate data generation part 311 transmits the generated CPU usage rate data to the pattern matching part 313 and the server 20. Note that a transmission interval of the CPU usage rate data to the server 20 is not limited particularly. The usage rate data generation part 311 may transmit the CPU usage rate data to the server 20 in a predetermined interval of time. Depending on performance of the CPU 11 and a type of the application to be executed, the transmission interval of the CPU usage rate data to the server 20 may be changed.

In step S102, the pattern data storge part 312 judges whether the CPU usage rate threshold patten data is or not transmitted from the server 20. When the pattern data storage part 312 judges that the CPU usage rate threshold patten data is transmitted from the server 20 (YES in step S102), the processing advances to step S103. Meanwhile, when the pattern data storage part 312 judges that the CPU usage rate threshold patten data is not transmitted from the server 20 (NO in step S102), the processing returns to step S101.

In step S103, the pattern storage part 312 stores the CPU usage rate threshold pattern data transmitted from the server 20.

In step S104, the pattern matching part 313 compares the latest CPU usage rate data of each of the plurality of CPUs 11 outputted from the usage rate data generation part 311 and the CPU usage rate threshold pattern data stored in the pattern data storage part 312. By this comparison processing, the pattern matching part 313 predicts a state in which the CPU usage rate exceeds the threshold value. When judging that the latest CPU usage rate data and the CPU usage rate threshold pattern data match with each other (YES in step P104), the pattern matching part 313 predicts that the CPU usage rate exceeds the threshold value in the future and the processing advances to step S105. Meanwhile, when judging that the latest CPU usage rate data and the CPU usage rate threshold pattern data do not match with each other (NO in step P104), the pattern matching part 313 predicts that the CPU usage rate does not exceed the threshold value in the future and the processing ends. In this case, an application allocation change processing is not performed.

In step S105, by judging a vacant situation of the CPU usage rate of the other CPU 11 that becomes a change destination of the allocation of the application, the pattern matching part 313 determines whether the allocation of the application can be changed or not. Specifically, when the latest CPU usage rate data of any one CPU 11 among the plurality of CPUs 11 and the CPU usage rate threshold pattern data match with each other, that is, when it is predicted that the CPU usage rate exceeds the threshold value, the pattern matching part 313 judges whether the other CPU 11 among the plurality of CPUs 11 has not a vacancy of the CPU usage rate necessary for executing a part of the application allocated to the CPU 11 in which the CPU usage rate exceeding the threshold value is predicted.

When the pattern matching part 313 judges that the other CPU 11 has the vacancy of the CPU usage rate necessary for executing the application whose allocation destination is changed (YES in step 105), the processing advances to step S106. Meanwhile, when the pattern matching part 313 judges that the other CPU 11 does not have the vacancy of the CPU usage rate necessary for executing the application whose allocation destination is changed (NO in step 105), the processing flow ends and the processing of the allocation change of the application is not performed.

In step S106, the pattern matching part 313 generates the application allocation change request. The application allocation change request includes information on the application to be an object of the allocation change and information on the CPU 11 to be the allocation destination.

In this way, in steps S104 and S105, the pattern matching part 313 compares the lates CPU usage rate data of each of the plurality of CPUs and the CPU usage rate threshold pattern data, and generates the application allocation change request. In addition, by comparing the lates CPU usage rate data of each of the plurality of CPUs and the CPU usage rate threshold pattern data, the pattern matching part 313 predicts the state in which the CPU usage rate exceeds the threshold value in the future. Based on this prediction result, the application allocation change request is generated.

In step S107, the application allocation control unit 32 changes the allocation destination, which is allocated to any one CPU 11 among the plurality of CPUs 11, to the other CPU 11 among the plurality of CPUs 11 based on the application allocation change request. Consequently, a series of processing flows shown by FIG. 5 ends.

FIG. 6 is a flowchart showing one example of a processing flow of the server 20. The flowchart of FIG. 6 includes four processing steps composed of steps S201 to S204.

In step S201, the usage rate data accumulation unit 41 receives, from the semiconductor device 10, the CPU usage rate data of each of the plurality of CPUs 11. The usage rate data accumulation unit 41 accumulates the received CPU usage rate data.

In step S202, the pattern analysis unit 42 accesses the CPU usage rate data of each of the plurality of CPUs 11 accumulated in the usage rate data accumulation unit 41, analyzes the CPU usage rate data of each of the plurality of CPUs 11 accumulated, and generates the CPU usage rate threshold pattern data. The analysis of the CPU usage rate data by the pattern analysis unit 42 is performed by using a time series data prediction model to perform the future prediction of the CPU usage rate. The pattern analysis unit 42 generates, as the CPU usage rate threshold pattern data, the time series fluctuation pattern of the CPU usage rate assumed to exceed the threshold value in the future based on an analysis result(s).

In step 203, the pattern analysis unit 42 judges whether the CPU usage rate threshold pattern data needs to be updated. Here, when the CPU usage rate threshold patten data generated this time is the same as the CPU usage rate threshold pattern data already transmitted to the semiconductor device 10 in the past processing, it is judged that the CPU usage rate threshold pattern data does not need to be updated. Meanwhile, when the CPU usage rate threshold pattern data generated this time is not the same as the CPU usage rate threshold pattern data already transmitted to the semiconductor device 10 in the past processing, it is judged that the CPU usage rate threshold pattern data needs to be updated.

When the pattern analysis unit 45 judges that the CPU usage rate threshold pattern data needs to be updated (YES in step S203), the processing advances to step S204. Meanwhile, the pattern analysis unit 45 judges that the CPU usage rate threshold pattern data does not need to be updated (NO in step S203), the processing returns to step S201.

In step S204, the pattern analysis unit 42 transmits, to the semiconductor device 10, the CPU usage rate threshold pattern data which it is judged that needs to be updated. Consequently, the series of processing flows shown in FIG. 6 ends.

As described above, according to the embodiment of the present disclosure, the application allocation judgement unit 31 compares the CPU usage rate data and the CPU usage rate threshold pattern data, thereby predicting the state in which the CPU usage rate exceeds the threshold value and generating the application allocation change request. The application allocation control unit 32 changes the allocation destination of the application to the other CPU 11 from the CPU 11, which predicts that the CPU usage rate exceeds the threshold value, based on the application allocation change request. The processing of the allocation change of the application is performed before the CPU usage rate actually exceeds the threshold value, so that an occurrence risk such as the deterioration of the response of the user interface can be reduced. In addition, since setting the low threshold value is not for preventing a state of the high CPU usage rate from continuing, it can prevent the resource of the CPU from be allocated at the switching processing occurring for the allocation change of the application and maintenance of the performance can be achieved.

Note that in the above embodiment, the accumulation and the analysis of the CPU usage rate data over a long period of time becomes necessary, so that the configuration in which the functions of the usage rate data accumulation unit 41 and the pattern analysis unit 42 are realized on a server 20 side has been explained. However, the present embodiment is not limited to this. For example, if a semiconductor device 10 side (edge side) can ensure sufficient resources, the semiconductor device 10 side may have the functions of the usage rate data accumulation unit 41 and the pattern analysis unit 42.

As described above, the invention made by the present inventors has been specifically explained based on the embodiments, the present invention is not limited to the already-described embodiments and, needless to say, can variously be modified within a range of not departing from a gist thereof.

What is claimed is:

1. A semiconductor device having a plurality of CPUs each executing an application allocated among a plurality of applications, the semiconductor device comprising:
an application allocation judgement unit comparing latest CPU usage rate data of each of the plurality of CPUs and CPU usage rate threshold pattern data, and generating an application allocation change request; and
an application allocation control unit changing an allocation destination of the application, which is allocated to any one CPU among the plurality of CPUs, to the other CPU among the plurality of CPUs based on the application allocation change request,
wherein the CPU usage rate threshold pattern data is generated by analyzing accumulated CPU usage rate data of each of the plurality of CPUs, and
wherein the application allocation judgement unit compares the latest CPU usage rate data of the any one CPU and the CPU usage rate threshold pattern data, thereby predicting a state in which the CPU usage rate of the any one CPU exceeds a threshold value and generating the application allocation change request.

2. The semiconductor device according to claim 1,
wherein the CPU usage rate threshold pattern data is time series fluctuation pattern data of an average CPU usage rate per certain period of time.

3. The semiconductor device according to claim 1,
Wherein the accumulated CPU usage rate data is analyzed by performing future prediction of the CPU usage rate obtained by using a time series data prediction model, and
Wherein the CPU usage rate threshold pattern data is time series fluctuation pattern data of the CPU usage rate assumed to exceed the threshold value in the future.

4. The semiconductor device according to claim 1,
Wherein the application allocation judgement unit includes:
a usage rate data generation part generating the CPU usage rate data of each of the plurality of CPUs;
a pattern data storage part storing the CPU usage rate threshold pattern data; and
a pattern matching part comparing the latest CPU usage rate data outputted from the usage rate data generation part and the CPU usage rate threshold pattern data stored in the pattern data storage part.

5. The semiconductor device according to claim 4,
wherein the patter matching part generates the application allocation change request when results obtained by comparing the latest CPU usage rate data and the CPU usage rate threshold pattern data match with each other and the other CPU has a vacancy of the CPU usage rate necessary for executing a part of the application allocated to the any one CPU.

6. The semiconductor device according to claim 4, further comprising:
a usage rate data accumulation unit accumulating the CPU usage rate data of each of the plurality of CPUs outputted from the usage rate data generation part; and
a pattern analysis unit analyzing the CPU usage rate data of each of the plurality of CPUs accumulated in the usage rate data storage part, and generating the CPU usage rate threshold pattern data.

7. An application allocation system comprising:
the semiconductor device according to claim 1; and
a server accessed from the semiconductor device via a network,
wherein the server has:
a usage rate data accumulation unit accumulating the CPU usage rate data of each of the plurality of CPUs transmitted from the semiconductor device; and
a pattern analysis unit analyzing the CPU usage date data of each of the plurality of CPUs accumulated in the usage rate data accumulation unit, and generating the CPU usage rate threshold pattern data.

8. The application allocation system according to claim 7,
wherein the pattern analysis unit uses a time series data prediction model to perform future prediction of the CPU usage rate, thereby analyzing the CPU usage rate data of each of the plurality of CPUs and generating, as the CPU usage rate threshold pattern data, a time series fluctuation pattern of the CPU usage rate assumed to exceed the threshold value in the future.

9. An application allocation method performed by a semiconductor device, the semiconductor device including a plurality of CPUs each executing an application allocated among a plurality of applications, the method comprising:
generating CPU usage rate data of each of the plurality of CPUs;
accumulating generated CPU usage rate data of each of the plurality of CPUs;
analyzing accumulated CPU usage rate date of each of the plurality of CPUs, and generating CPU usage rate threshold pattern data;
comparing latest CPU usage rate data of each of the plurality of CPUs and the CPU usage rate threshold pattern data, and generating an application allocation change request; and
changing an allocation destination of the application, which is allocated to any one CPU among the plurality of CPUs, to the other CPU among the plurality of CPUs based on the application allocation change request,
wherein generating the application allocation change request includes predicting a state in which the CPU usage rate of the any one CPU exceeds a threshold value by comparing the latest CPU usage rate data of the any one CPU and the CPU usage rate threshold pattern data, and
wherein the application allocation change request is generated based on a result obtained by performing the predicting of the state.

10. The application allocation method according to claim 9,
wherein the CPU usage rate threshold pattern data is time series fluctuation pattern data of an average CPU usage rate per certain period of time.

11. The application allocation method according to claim 9,
wherein generating the CPU usage rate threshold pattern data includes:
performing future prediction of the CPU usage rate obtained by using a time series data prediction model; and
generating, as the CPU usage rate threshold pattern data, time series fluctuation pattern of the CPU usage rate assumed to exceed the threshold value in the future.

12. The application allocation method according to claim 9,
Wherein generating the application allocation change request further includes:
judging whether the other CPU has a vacancy of the CPU usage rate necessary for executing a part of the application allocated to the any one CPU; and
generating the application allocation change request when results obtained by comparing the latest CPU usage rate data and the CPU usage rate threshold pattern data match with each other and the other CPU has the vacancy of the CPU usage rate necessary for executing the part of the application allocated to the any one CPU.

13. A non-transitory computer readable medium storing a program, the program causing a semiconductor device to perform an application allocation method, the semiconductor device having a plurality of CPUs each executing an application allocated among a plurality of applications,
the application allocation method comprising:
generating CPU usage rate data of each of the plurality of CPUs;
accumulating generated CPU usage rate data of each of the plurality of CPUS;
analyzing accumulated CPU usage rate data of each of the plurality of CPUs, and generating a CPU usage rate threshold pattern data;
comparing the latest CPU usage rate data of each of the plurality of CPUs and the CPU usage rate threshold pattern data, and generating an application allocation change request;
changing an allocation destination of the application, which is allocated to any one CPU among the plurality of CPUs, to the other CPU among the plurality of CPUs based on the application allocation change request,
wherein generating the application allocation change request includes comparing the latest application usage rate data of the any one CPU and the CPU usage rate threshold pattern data, thereby predicting a state in which the CPU usage rate of the any one CPU exceeds a threshold value, and
wherein the application allocation change request is generated based on a result of performing the predicting of the state.

14. The non-transitory computer readable medium according to claim 13,
wherein the CPU usage rate threshold pattern data is time series fluctuation pattern data of an average CPU usage rate per certain period of time.

15. The non-transitory computer readable medium according to claim 13,
wherein generating the CPU usage rate threshold pattern data includes:
performing future prediction of the CPU usage rate obtained by using a time series data prediction model; and
generating, as the CPU usage rate threshold pattern data, a time series fluctuation pattern of the CPU usage rate assumed to exceed the threshold value in the future.

16. The non-transitory computer readable medium according to claim 13,
wherein generating the application allocation change request further includes:
judging whether the other CPU has a vacancy of the CPU usage rate necessary for executing a part of the application allocated to the any one CPU; and
generating the application allocation change request when results obtained by comparing the latest CPU usage rate data and the CPU usage rate threshold pattern data match with each other and the other CPU has the vacancy of the CPU usage rate necessary for executing the part of the application allocated to the any one CPU.
